(19) United States
(12) Patent Application Publication
(10) Pub. No.: US 2010/0134911 A1
(43) Pub. Date: Jun. 3, 2010

(54) MULTI-PARAMETER OPTIMIZATION OF WRITE HEAD PERFORMANCE USING ADAPTIVE RESPONSE SURFACE

(76) Inventors: Zhen Jin, Fremont, CA (US); Kezhao Zhang, Fremont, CA (US)

Correspondence Address: ZILKA-KOTAB, PC- HIT, P.O. BOX 721120, SAN JOSE, CA, 95172-1120, US

(21) Appl. No.: 12/326,679

(22) Filed: Dec. 2, 2008

(51) Int. Cl. G11B 27/36

(52) U.S. Cl. 360/31; G9B/27.052

(57) ABSTRACT

A method for optimizing design parameters of a magnetic write head. The method involves compiling a table of data points for a plurality of design parameters. An experimentally derived optimal design point is determined a first set of tests are performed at this experimentally determined design point. A three dimensional response surface is generated based on the testing. Then, a projected optimal design point is determined from the three dimensional response surface. Another test is performed using this projected optimal design point, and a convergence is determined by comparing the results of the first and second tests. If the convergence is within a predetermined value, then the process is complete. If the convergence is not within the predetermined value, then the process is repeated using the most recent projected optimal design point.

### FIELD OF THE INVENTION

The present invention relates to perpendicular magnetic recording and more particularly to a method for optimizing write head performance by analyzing multiple write head performance parameters.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head has traditionally included a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic transitions in tracks on the moving media, such as in circular tracks on the aforementioned rotating disk.

In recent read head designs, a GMR or TMR sensor has been employed for sensing magnetic fields from the rotating magnetic disk. The sensor includes a nonmagnetic conductive layer, or barrier layer, sandwiched between first and second ferromagnetic layers, referred to as a pinned layer and a free layer. First and second leads are connected to the sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

In order to meet the ever increasing demand for improved data rate and data capacity, researchers have recently been focusing their efforts on the development of perpendicular recording systems. A traditional longitudinal recording system, such as one that incorporates the write head described above, stores data as magnetic bits oriented longitudinally along a track in the plane of the surface of the magnetic disk. This longitudinal data bit is recorded by a fringing field that forms between the pair of magnetic poles separated by a write gap.

A perpendicular recording system, by contrast, records data as magnetizations oriented perpendicular to the plane of the magnetic disk. The magnetic disk has a magnetically soft underlayer covered by a thin magnetically hard top layer. The perpendicular write bead has a write pole with a very small cross section and a return pole having a much larger cross section. A strong, highly concentrated magnetic field emits from the write pole in a direction perpendicular to the magnetic disk surface, magnetizing the magnetically hard top layer. The resulting magnetic flux then travels through the soft underlayer, returning to the return pole where it is sufficiently spread out and weak that it will not erase the signal recorded by the write pole when it passes back through the magnetically hard top layer on its way back to the return pole.

### SUMMARY OF THE INVENTION

The present invention provides a

A method for optimizing design parameters of a magnetic write head. The method involves compiling a table of data points for a plurality of design parameters. An experimentally derived optimal design point is determined. A first set of tests are performed at this experimentally determined design point. A three dimensional response surface is generated based on the testing. Then, a projected optimal design point is determined from the three dimensional response surface. Another test is performed using this projected optimal design point, and a convergence is determined by comparing the results of the first and second tests. If the convergence is within a predetermined value, then the process is complete. If the convergence is not within the predetermined value, then the process is repeated using the most recent projected optimal design point.

The parameters to be tested can be, for example, write current (iw), write current overshoot amplitude (OVA), and write current duration (OVD). The results of the testing can be, for example, a measurement of on track error rate.

The process can be described as an iterative process including the steps of, setting i=1, and then, in first step (step 1) constructing a table of data points for a plurality of parameters of a write head, and determining an experimentally determined optimal design point, and setting this experimentally determined optimal design point as the most current design point. Then, in s second step (step 2) an i(th) testing is performed and measurement is performed of the plurality of parameters of the write head using the most current design point, wherein the i(th) testing produces an i(th) result. Then, in a third step (step 3) an i(th) multidimensional response surface is generated based on the results of the i(th) testing and measurement. Then, in a fourth step (step 4) an i(th) projected optimal design point is determined on this surface, and this i(th) projected optimal design point is set as the most current design point. Then, in a fifth step (step 5) an i(th)+1 testing and measurement are performed of the plurality of parameters of the write head using the i(th) design point, wherein the i(th)+1 set of testing produces an i(th)+1 result. Then, in a sixth step (step 6) a convergence is determined based on a difference between the i(th) and i(th)+1 test result, and if the convergence exceeds a predetermined threshold, then “i” is set to i=i+1, and steps 1-6 are reiterated.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view, taken from line 3-3 of FIG. 2 and rotated 90 degrees counterclockwise, of a magnetic write head according to an embodiment of the present invention;

FIG. 4 is a flowchart illustrating an optimization process according to an embodiment of the invention;

FIG. 5 is an example of a table of design points for use in an optimization process according to an embodiment of the invention;

FIG. 6 is a graph of write current vs. overshoot amplitude;

FIG. 7 is a graph of write current vs. write current vs. duration; and

FIG. 8 is a graph of duration vs. overshoot amplitude.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

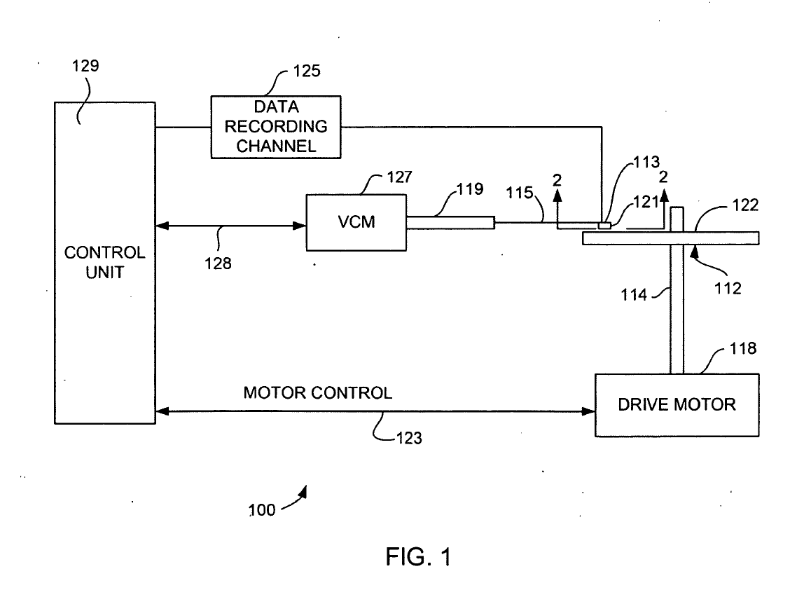

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

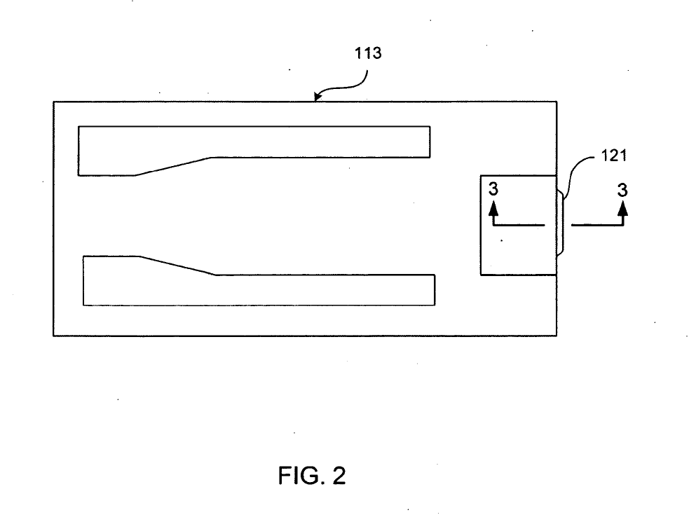

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

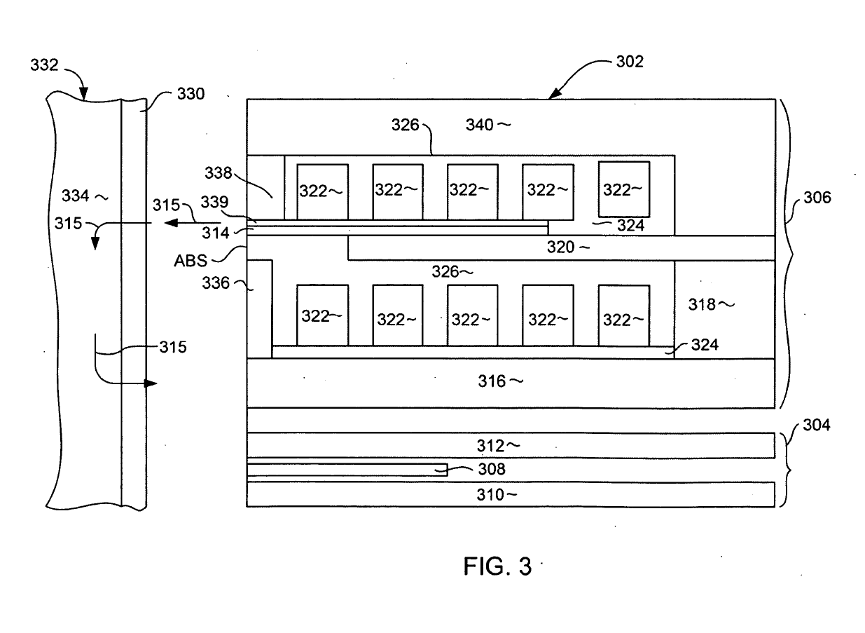

FIG. 3 shows a magnetic head 302 such as might be used to read and write date from and to a magnetic disk. The magnetic head 302 includes a read head 304 and a write head 306. The read head 304 includes a magnetoresistive sensor 308, which can be a GMR, TMR, or some other type of sensor. The magnetoresistive sensor 308 is located between first and second magnetic shields 310, 312.

The write head 306 includes a magnetic write pole 314 and a magnetic return pole 316. The write pole 314 can be formed upon a magnetic shaping layer 320, and a magnetic back gap layer 318 magnetically connects the write pole 314 and shaping layer 320 with the return pole 316 in a region removed from the air bearing surface (ABS). A write coil 322 (shown in cross section in FIG. 3) passes between the write pole and shaping layer 314, 320 and the return pole 316, and may also pass above the write pole 314 and shaping layer 320. The write coil can be a helical coil or can be one or more pancake coils. The write coil 322 can be formed upon an insulation layer 324 and can be embedded in a coil insulation layer 326 such as alumina and or hard baked photoresist.

In operation, when an electrical current flows through the write coil 322. A resulting magnetic field causes a magnetic flux to flow through the return pole 316, back gap 318, shaping layer 320 and write pole 314. This causes a magnetic write field 315 to be emitted from the tip of the write pole 314 toward a magnetic medium 332. The write pole 314 has a cross section at the ABS that is much smaller than the cross section of the return pole 316 at the ABS. Therefore, the magnetic field 315 emitting from the write pole 314 is sufficiently dense and strong that it can write a data bit to a magnetically hard top layer 330 of the magnetic medium 332. The magnetic field 315 then flows through a magnetically softer under-layer 334, and returns back to the return pole 316, where it is sufficiently spread out and weak that it does not erase the data bit recorded by the write head 314. A magnetic pedestal 336 may be provided at the air bearing surface ABS and attached to the return pole 316 to prevent tray magnetic fields from the bottom leads of the write coil 322 from affecting the magnetic signal recorded to the medium 332.

In order to increase write field gradient, and therefore increase the speed with which the write head 306 can write data, a trailing, wrap-around magnetic shield 338 can be provided. The trailing, wrap-around magnetic shield 338 is separated from the write pole by a non-magnetic write gap 339, and may be connected with the shaping layer 320 and/or back gap 318 by a trailing return pole 340. The trailing shield 338 attracts the magnetic field from the write pole 314, which slightly cants the angle of the magnetic field 315 emitting from the write pole 314. This canting of the write field 315 increases the speed with which write field polarity can be switched by increasing the field gradient. A trailing magnetic return pole 340 is provided and can be magnetically connected with the trailing shield 338. Therefore, the trailing return pole 340 can magnetically connect the trailing magnetic shield 338 with the back portion of the write pole 302, such with the back end of the shaping layer 320 and with the back gap layer 318. The magnetic trailing shield is also a second return pole so that in addition to magnetic flux being conducted through the medium 332 to the return pole 316, the magnetic flux also flows through the medium 332 to the trailing return pole 340.

In the operation of the write head 306, several parameters affect the performance of the write head. These parameters have to do with the amount and nature of the electrical current supplied to the write coil 322 and the strength and nature of the resulting magnetic write field 315. Examples of such parameters are write current amplitude (iw), write current overshoot amplitude (OVA) and write current duration (OVD). The write current amplitude (iw) is the amplitude of the steady state write current applied to the write coil 322. The write current overshoot amplitude (OVA) is the amplitude of the overshoot above the steady state write current applied. Write current duration is the length of time that write current overshoot is applied.

In previous designs and optimizations of write heads, these parameters were calculated separately and independently from one another. For example, 2-parameter optimization consisted of two one-dimensional scans. This method has several disadvantages. First, when performing such a one dimensional scan, a vast majority of design points are omitted. For example, instead of probing a 2-dimensional surface of a 2-parameter design space, one will just be looking at 2 lines on the plot surface. This will certainly provide less than optimal results, especially in most practical cases where there is an interaction between parameters. Second, this conventional method results in different optimized design points based on which starting point is used. This artificial instability is not desirable.

By contrast, the present invention provides a method for optimizing parameters that takes into account the interaction between parameters by testing and plotting multiple parameters in unison, thereby allowing the operator to optimize the design space, while taking into account the interaction between variables.

First, a full response surface is constructed using Design of Experiments (DOE) test points, and then optimized on the surface to find the projected optimal point (POD). Optimization is improved iteratively using the tests on the POD. This eliminates the problems associated with prior art testing methods, because the whole surface is being probed. In addition, one can perform “constraint” or “robust” optimization. Using a testing method according to the present invention, the optimization speed is improved or at least maintained.

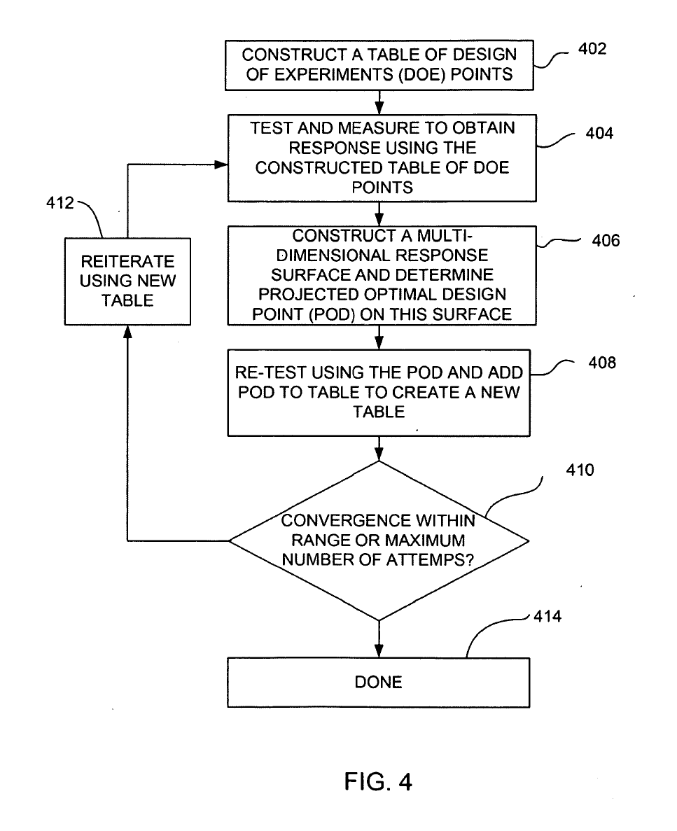

An optimization method according to the present invention is described with reference to FIG. 4. First, in a step 402 a table is constructed using design of experiment (DOE) points. These are design points determined experimentally, and can be considered to be a first best guess estimate. These DOE points are used as a starting point in the optimization. Then, in a step 404 testing and measurement are performed to obtain a response (e.g. error rate) using this pre-constructed table of DOE points. Then, in a step 406 a multi-dimensional response surface is constructed, and an optimal design point is found on this multi-dimensional response surface. This optimal design point can be called the Projected Optimal Design point (POD). Then, in a step, 408, another set of testing is performed using this new POD resulting in new set of results, and the POD is added into the table to create a new table. Then, in a decision step 410 a determination is made as to whether a predetermined reasonable convergence has been met, or a predetermined maximum number of attempts has been made. If the answer to step 410 is no, then the process returns to reiterate (412) the steps 404, 406, 408 using the new table. If the answer to decision step 410 is yes, then the process is complete 414 and the optimal design points have been found.

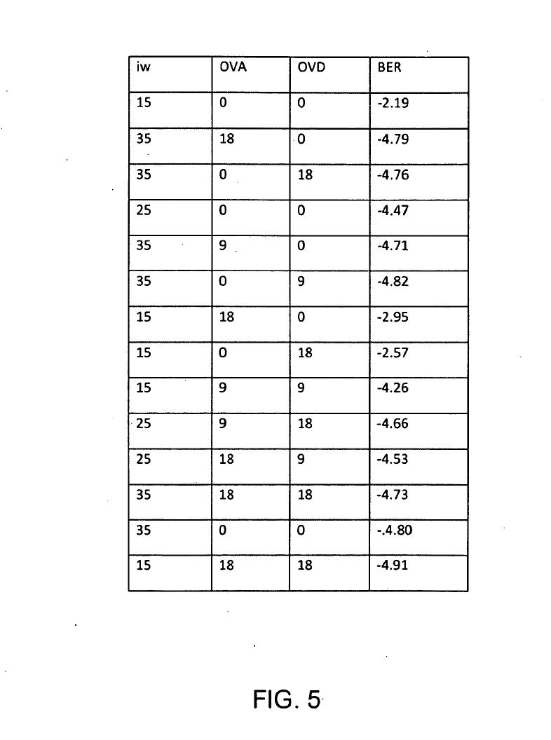

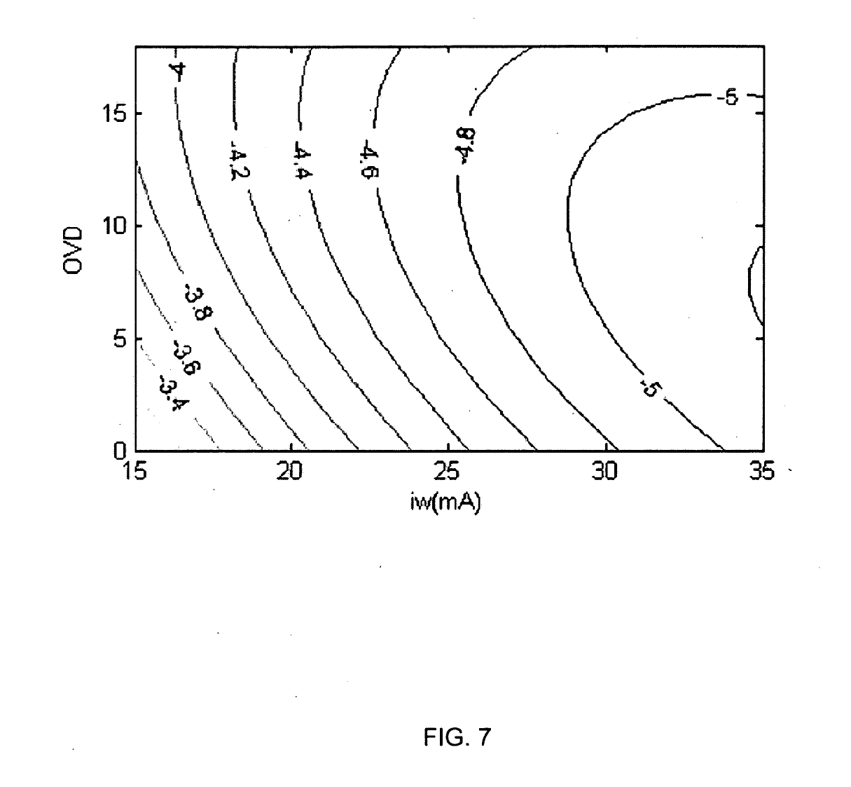

FIGS. 5-7 illustrate an example of the use of the above described testing method as applied a magnetic write head and the optimization of three parameters: write current (iw), current overshoot amplitude (OVA) and current duration (OVD). The response to be monitored in this case is the on-track error rate (BER). With reference to FIG. 5, a table is constructed using a sufficient number of DOE points to allow a quadratic surface to be constructed. In this case 14 design points are more than sufficient, and a BER value is measured for each point.

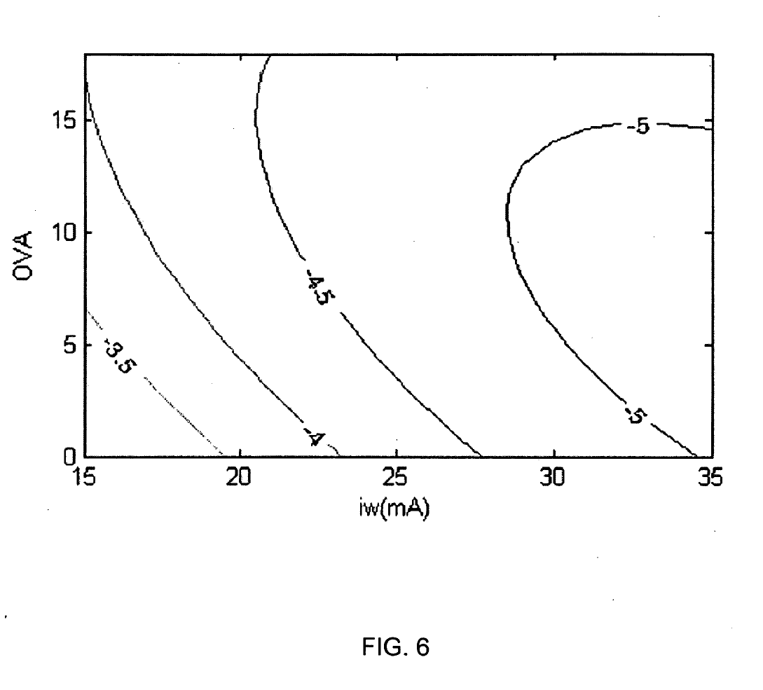

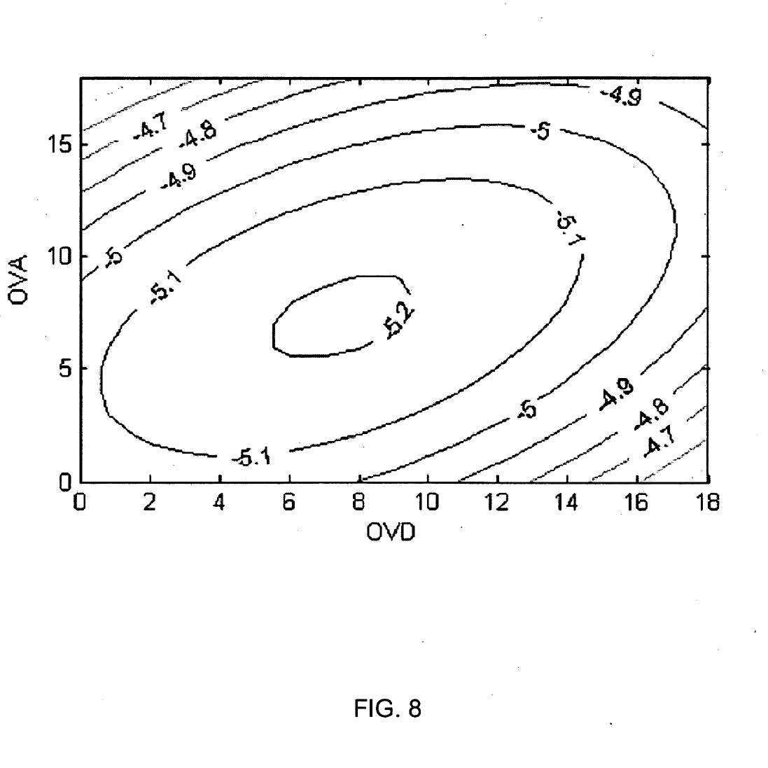

With reference to FIGS. 6-8, a four dimensional, quadratic response surface is generated using the data from the table. Each of the graphs in FIGS. 6-8 represents a section of a four dimensional graph that includes an axis for iw, an axis for OVD and an axis for OVA. From this surface plot, a global optimal can be found that is robust against perturbation. For example, in the present example, a BER of −5.21 is a projected response for design points of: iw=35, OVA=7, and OVD=7. Using these design points in the iterative process described above (ie. performing measurements using these design points) obtains a BER of −4.98. Plugging this design point back into the table (FIG. 5) and recreating the quadratic surface plot (discussed previously with respect to FIGS. 6-8), the same optimal design point is predicted (e.g. iw=35, OVA=7, OVD=7 and BER=−5.11). Thus the design point optimization converges.

It takes 16 steps to obtain an optimal design, which roughly requires about the same amount of time as a 3 parameter 5-step one dimensional search. However, the optimal design point obtained by the present method is consistent and unique.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for optimizing parameters of a magnetic write head, comprising:
constructing a table of data points for a plurality of parameters of a write head;
performing a first testing and measurement of the plurality of parameters of the write head;
constructing a multidimensional response surface based on the results of the first testing and measurement;
determining a projected optimal design point on this surface; and
performing a second testing and measurement of the plurality of parameters of the write head using the projected optimal design point on the multidimensional response surface.

2. The method of claim 1 further comprising after performing the second testing and measurement, determining a convergence of results between the first and second tests.

3. The method of claim 1 further comprising:
after performing the second testing and measurement, determining a convergence of results between the first and second tests;
determining whether the convergence is within a predetermined range, and
if the convergence is not within a predetermined range, reiterating the process by performing the steps of:
performing a third testing and measurement of the plurality of parameters of the write head based on the second test;
constructing a second multidimensional response surface based on the results of the third testing and measurement;
determining a projected optimal design point on this second surface.

4. The method of claim 1 wherein the table of data points includes experimentally derived data points.

5. The method of claim 1 wherein the parameters of the write head include write current, write current overshoot, and write current duration.

6. A method as in claim 1 wherein the response of the first testing comprises an on track error rate (BER).

7. A method for optimizing performance of a magnetic write head, comprising:
constructing a table of data points based on three parameters of a write head;
performing a first set of testing of the write head based on data from the first table of data points, the testing providing first set of test results;
constructing a first three dimensional response surface based on the first set of test results;
using the three dimensional response surface to determine a projected optimal design point;
performing a second set of testing using the projected optimal design point, the second set of testing providing a second set of test results; and
determining a convergence based on the difference between the first and second sets of test results.

8. A method as in claim 7 wherein the three parameters of the write head comprise write current amplitude (iw), write current overshoot (OVA) and write current duration (OVD).

9. A method as in claim 7 wherein the results of the first and second test results comprise on track error rate.

10. A method as in claim 7 wherein the three parameters of the write head comprise write current amplitude (iw), write current overshoot (OVA) and write current duration (OVD) and wherein the results of the first and second test results comprise on track error rate.

11. A method as in claim 7, further comprising, if the convergence is not within a predetermined threshold:
performing a second set of testing using the projected optimal design point, the second set of testing producing a second set of test results;
constructing a second three dimensional response surface based on the results of the second set of testing, and find a second projected optimal design point on the second three dimensional response surface; and
determining a second convergence based on the second set of test results.

12. A method as in claim 7, further comprising, if the convergence is not within a predetermined threshold:
performing a second set of testing using the projected optimal design point, the second set of testing producing a second set of test results;
constructing a second three dimensional response surface, and finding a second projected optimal design point on this surface;
performing a third set of testing using the second projected optimal design point, the third set of testing producing a third set of test results; and
determining a second convergence based on the second set of test results; and
if the second convergence is not within the predetermined threshold, then:
performing a fourth set of testing using the second projected optimal design point;
constructing a third three dimensional response surface based on the results of the fourth set of testing, and finding a third projected optimal design point on this surface;
performing a fifth set of testing using second projected optimal design point, the fifth set of testing producing a fifth set of test results; and
determining a third convergence based on the difference between the fourth and fifth test results.

13. A method for optimizing parameters of a magnetic write head, comprising:
setting i=1;
(step 1) constructing a table of data points for a plurality of parameters of a write head, and determining an experimentally determined optimal design point, and setting this experimentally determined optimal design point as the most current design point;
(step 2) performing a i(th) testing and measurement of the plurality of parameters of the write head using the most current design point, the i(th) testing producing an i(th) result;
(step 3) constructing an i(th) multidimensional response surface based on the results of the i(th) testing and measurement;
(step 4) determining an i(th) projected optimal design point on this surface, and setting this i(th) projected optimal design point as the most current design point;
(step 5) performing an i(th)+1 testing and measurement of the plurality of parameters of the write head using the i(th) design point, the i(th)+1 set of testing producing an i(th)+1 result;
(step 6) determining a convergence based on a difference between the i(th) and i(th)+1 test result; and
if the convergence exceeds a predetermined threshold, then setting i=i+1, and reiterating steps 1-6.

14. A method as in claim 13, wherein the plurality of parameters comprise, write current (iw), write current overshoot (OVA) and write current duration (OVD).

15. A method as in claim 13, wherein the i(th) result and i(th)+1 result each comprise on track error rate (BER).

16. A method as in claim 13 further comprising, terminating the process if “i” reaches a predetermine value.

17. A method as in claim 13 wherein the plurality of parameters comprise, write current (iw), write current overshoot (OVA) and write current duration (OVD), and wherein the i(th) result and i(th)+1 result each comprise on track error rate (BER).
